(19) United States
(12) Patent Application Publication
(10) Pub. No.: US 2026/0276511 A1
(43) Pub. Date: Sep. 17, 2026

(54) METHOD AND DEVICE FOR DETERMINING THE PARTICLE SIZE IN A FLOWING SAMPLE

(71) Applicant: Fraunhofer-Gesellschaft zur Förderung der angewandten Forschung E.V., München (DE)

(72) Inventors: Cornelius BAUSCH, Mainz (DE); Peter HÖBEL, Mainz (DE); Michael MASKOS, Mainz (DE)

(21) Appl. No.: 19/168,528

(22) PCT Filed: Mar. 25, 2024
(86) PCT No.: PCT/EP2024/057926

§ 371 Date: Sep. 24, 2025

(30) Foreign Application Priority Data
Mar. 27, 2023 (DE) 10 2023 107 607.8

(51) Int. Cl. G01N 15/0205; G01N 15/0227

(52) U.S. Cl. CPC G01N 15/0211; G01N 15/0227

(57) ABSTRACT

A method and a device for determining the average particle size of particles in a flowing liquid medium by means of dynamic light scattering (DLS). The medium is conveyed through an optically transparent channel during which time the medium is irradiated with laser light, scattered laser light is detected in a two-dimensional spatially resolved manner, wherein two images forming an image pair are generated in succession with a specific delay time τ and wherein at least two image pairs with different delay times τ are generated, the scattered light patterns of the images of each image pair are brought into coincidence with each other by means of relative displacement, wherein a maximum correlation value and a displacement amount s are respectively determined, a displacement velocity v is determined from at least one of the displacement amount s and from the associated delay time τ, a coefficient of a correlation function g₂(τ) that is dependent on the delay time τ is determined from the correlation values of the at least two image pairs, and a value for the average particle size is derived from the at least one coefficient, wherein a correction is made as a function of the determined displacement velocity v.

### CROSS-REFERENCE TO RELATED APPLICATIONS

This application is the U.S. national stage application of International Patent Application No. PCT/EP2024/057926, filed Mar. 25, 2024, which claims the benefit under 35 U.S.C. § 119 of German Application No. 10 2023 107 607.8, filed Mar. 27, 2023, the disclosures of each of which are incorporated herein by reference in their entirety.

### FIELD OF THE INVENTION

The invention relates to a method and a device for determining the average particle size of particles in a flowing liquid medium by means of dynamic light scattering (DLS).

### BACKGROUND

Dynamic light scattering (DLS) is a method for determining particle size in which a particle suspension to be examined is irradiated with coherent laser light. The light scattered by the particles is used to measure the velocity of the Brownian motion of the particle sample, from which the size of the particles is derived using the Stokes-Einstein relation.

When measuring particles that are suspended in a flowing medium, also referred to herein as a sample, the Brownian motion must be separated out from the flow motion of the sample in order to obtain the most accurate possible results. This problem has already been addressed in DE 10 2016 212 164 B3. It discloses a method in which a liquid medium is conveyed through an optically transparent channel in which a laminar flow propagates, the liquid medium is irradiated by means of laser light, scattered laser light is detected in a two-dimensional spatially resolved manner by means of one or more optical detectors such that an image is generated, wherein each image has a scattered light pattern, wherein two images forming an image pair are generated in succession with a specific delay time τ, and wherein at least two image pairs with different delay times τ are generated, the scattered light patterns of the images of each image pair are brought into coincidence with each other by means of relative displacement and, if two optical detectors are used, optionally rotation relative to each other, wherein a maximum correlation value is determined in each case. This correlation value is subject to an exponential decay depending on the delay time. Based on this knowledge, a coefficient, the decay constant, of a correlation function g₂(τ), also known as autocorrelation, which is dependent on the delay time τ, is determined from the correlation values of the at least two image pairs by means of a numerical fitting, and the hydrodynamic radius r_{H} of the particles is derived from this.

The separation of the movement of the flowing medium from the Brownian motion actually to be measured, also referred to as “flow compensation” herein, is achieved through determination of the maximum correlation values on the one hand and through linear displacement of the scattered light patterns on the other. The particle sizes derived from the measurement that is compensated for in this way are already significantly more accurate than those derived from a static, i.e. uncompensated, measurement. The derived value of the particle size, however, still exhibits deviations and is therefore an inducement to improve the known method.

Embodiments of the invention improve upon the known method with regard to the accuracy of the particle size determination.

### SUMMARY OF THE INVENTION

In the method according to the invention, the medium is conveyed through an optically transparent channel in a step a), the medium is irradiated by means of laser light during this in a step b), scattered laser light is detected in a two-dimensional spatially resolved manner by means of one or more optical detectors in a step c) such that an image is generated, wherein each image has a scattered light pattern, wherein two images forming an image pair are successively generated with a specific delay time τ, and wherein at least two image pairs with different delay times r are generated, the scattered light patterns of the images of each image pair are brought into coincidence in a step d) at least by means of a relative displacement with respect to each other, wherein a maximum correlation value and a displacement amount s are respectively determined, in a step e) a displacement velocity v is determined from at least one of the displacement amounts s of the at least two image pairs and from the associated delay time τ, and in a step f) at least one coefficient of a correlation function g₂(τ) that is dependent on the delay time τ is determined from the correlation values of the at least two image pairs by means of a numerical fitting and a value for the average particle size is derived from the at least one coefficient, wherein a correction is made as a function of the determined displacement velocity v.

The invention is based on the realization that the deviations observed between the hydrodynamic radii determined in the known manner and the actual particle size are due to a non-homogeneous velocity distribution of the flowing medium inside the channel. The smaller the channel is at a constant flow rate, the more non-homogeneous the velocity profile becomes, even if the flow still remains laminar. This is due to an increase in shear with decreasing distance from the channel wall. The correction according to the invention when determining the value for the particle size is therefore also referred to as “shear compensation” below. When using the method for determining the particle size described in DE 10 2016 212 164 B3, the average particle radius is therefore determined to be too small as soon as a significant variation in the flow profile occurs. To counteract this phenomenon, the laser beam can be focused as precisely as possible on the center of the channel, where the flow velocity exhibits the least variation in laminar flow and only particles with almost the same velocity scatter the light of the laser beam. This leads to minor measurement errors, even with channel cross-sections of up to 7 mm. With smaller channel cross-sections, in particular with a size below one millimeter, the shear forces are no longer negligible, even with stronger focusing of the laser, and the flow compensation is no longer sufficient to achieve satisfactory results in the particle size determination. For example for particles with a diameter of 200 nm, the relative measurement error caused by the shear is already 50% with a channel cross-section of 0.5 mm and a flow rate of 500 μl/min. The invention is therefore particularly important for the analysis of small quantities of liquid in the ml or μl range, so-called microfluidics.

The invention is also based on the consideration that the shear occurring along the edge of the channel is proportional to the flow velocity or flow rate, from which the inventors drew the conclusion that compensating for this effect by means of a velocity-dependent correction is a promising approach. And finally, the invention is based on the realization that a parameter proportional to the flow velocity in the form of a displacement amount s is already determined during the flow compensation in step d). In step e), the flow velocity can therefore be determined without additional measurement from the displacement amount, which can be measured in pixels in a digital image acquisition, for example, and from the already determined displacement time. For example, the flow velocity is recorded in the unit pixel/μs and is available for a velocity-dependent correction of the measurement result. In principle, it is sufficient if this determination of the velocity is carried out based on one pair of images from a measurement since the flow rate is constant within a measurement. Preferably, however, the displacement velocity v is determined in step e) from the displacement amounts sᵢ and from the associated delay times τᵢ of at least two image pairs by averaging, particularly preferably according to the following formula

$$v = \frac{{\sum }_{i} {s}_{i}}{{\sum }_{i} {τ}_{i}} .$$

This reduces the statistical error in the velocity determination because longer delay times are weighted more heavily.

If two optical detectors are used, in addition to the obligatory relative displacement of the scattered light patterns to compensate for the flow, it can also be necessary to subject the scattered light patterns to a static calibration consisting of a relative displacement and relative rotation to each other in order to be able to compensate for any translational and rotational imaging errors due to misalignments of the detectors in relation to each other. This static calibration is only an optional correction insofar as it can be omitted, for example, if only one detector is used to produce the two images of an image pair or if two detectors are aligned with pixel accuracy. Step d) above refers to “at least by means of relative displacement” in this sense.

Preferably, the correlation function g₂(τ) is an exponential function and the at least one determined coefficient is the decay rate Γ(v). This is preferably no different in the method according to the invention than it is in the above-mentioned prior art.

The correlation function is advantageously specified by means of least-squares fitting with the following exponential function according to B. J. Frisken, Revisiting the method of cumulants for the analysis of dynamic light-scattering data, Applied optics 40 (24), pp. 4087-4091, 2001, DOI: 10.1364/ao.40.004087

$${g}_{2} ( τ ) = {b}_{0} + βexp ( - 2 Γ ( v ) τ ) \cdot {( 1 + {\sum }_{n = 2}^{∞} {( - 1 )}^{n} \frac{{μ}_{n}}{n !} {τ}^{n} )}^{2} , \qquad ( 1 )$$

where b₀ is the baseline of the correlation function, β is a parameter for compensation of the measurement sensitivity, and the coefficients μₙ of the series

$${\sum }_{n = 2}^{∞} {( - 1 )}^{n} \frac{{μ}_{n}}{n !} {τ}^{n}$$

are parameters for describing the decay rate distribution and where the series

$${\sum }_{n = 2}^{∞} {( - 1 )}^{n} \frac{{μ}_{n}}{n !} {τ}^{n}$$

is optionally set equal to zero or terminated after the first summand

$$\frac{{μ}_{2}}{2 !} {τ}^{2}$$

or later.

Alternatively, the correlation function is advantageously specified by means of least-squares fitting with the following exponential function

$${g}_{2} ( τ ) = {b}_{0} + βexp ( - 2 Γ ( v ) τ + 2 \cdot {\sum }_{n = 2}^{∞} {( - 1 )}^{n} \frac{{κ}_{n}}{n !} {τ}^{n} ) , \qquad ( {1}^{′} )$$

where b₀ is the baseline of the correlation function, β is a parameter for compensation of the measurement sensitivity, and the coefficients κₙ of the series

$${\sum }_{n = 2}^{∞} {( - 1 )}^{n} \frac{{κ}_{n}}{n !} {τ}^{n}$$

are parameters for describing the decay rate distribution and where the series

$${\sum }_{n = 2}^{∞} {( - 1 )}^{n} \frac{{κ}_{n}}{n !} {τ}^{n}$$

is optionally set equal to zero or terminated after the first summand

$$\frac{{κ}_{2}}{2 !} {τ}^{2}$$

or later.

μ₂ and κ₂, respectively, can be used to calculate the dispersity, which is a measure of the width of the particle size distribution. μ₂=0 and κ₂=0, respectively, corresponds to an assumed monomodal particle size distribution with a width of zero (delta function). This approximation is completely sufficient in many practical cases. In this instance, the series is terminated after the first summand (1), i.e. the bracketed expression after the exponential term is omitted.

The correction in step f) advantageously depends in linear fashion on the determined displacement velocity v. This keeps the computational effort low and has proven to be a sufficient correction to reduce the error. Thus under the conditions taken as a basis above (0.5 mm channel cross-section and 500 μl/min flow rate), the relative error of the determined particle diameter for particles with a diameter of 200 nm is only 3%.

The correction in step f) can be carried out, for example, by inserting a velocity-dependent correction term into the correlation function g₂(τ), for example according to (1) or (1′), or by means of a velocity-dependent correction of the at least one determined coefficient or by means of a velocity-dependent correction of the derived hydrodynamic radius r_{H} itself.

In particular, all mathematically equivalent arithmetic operations for velocity-dependent correction are included in the invention.

The decay rate Γ(v) in step f) is advantageously corrected according to the following formula

$${Γ}_{0} = Γ ( v ) - m \cdot v \qquad ( 2 )$$

or alternatively by inserting the following correction term

$$Γ ( v ) = m \cdot v + {Γ}_{0} \qquad ( 3 )$$

into the correlation function g₂(τ), for example according to (1) or (1′), where in each case, F₀ is the corrected decay rate and m is a parameter from a calibration of the decay rate determination with variation of the displacement velocity v. The corrected decay rate corresponds to the measured decay rate at a displacement velocity of 0: Γ₀=Γ(v=0). In the former case, the decay rate would first be determined from the correlation function by means of fitting and then the result would be corrected and in the latter case, the correction would be included in the correlation function. These are two equivalent and therefore interchangeable calculation steps. In both cases, the correction is linearly dependent on the displacement velocity.

According to an advantageous embodiment of the method, in order to calibrate the decay rate determination for at least two different displacement velocities vᵢ, the decay rate Γ(vᵢ) is determined according to steps a) to f), but without correction, and a straight line is derived from the value pairs [vᵢ,Γ(vᵢ)], the slope of which constitutes the parameter m for the function (2) or (3).

This can be done, for example, by using two value pairs n [vᵢ,Γ(vᵢ)] to produce the difference quotient

$$m = \frac{Γ ( {v}_{2} ) - Γ ( {v}_{1} )}{{v}_{2} - {v}_{1}}$$

or by determining a linear equation by means of a linear fit with at least two value pairs [vᵢ,Γ(vᵢ)], the slope of which constitutes the parameter m.

Alternatively, the decay rate Γ(v) is corrected in step f) according to the following formula

$${Γ}_{0} = \frac{Γ ( v ) - B \cdot v}{1 + A \cdot v} \qquad ( 4 )$$

or alternatively the following correction term

$$Γ ( v ) = {Γ}_{0} \cdot ( A \cdot v + 1 ) + B \cdot v \qquad ( 5 )$$

is inserted into the correlation function g₂(τ), for example according to (1) or (1′), where F₀ is the corrected decay rate and A and B are coefficients from a calibration of the decay rate determination with variation of the displacement velocity v. Here too, in the former case, the decay rate would first be determined from the correlation function by means of fitting and then the result would be corrected and in the latter case, the correction would be included in the correlation function. Once again, these are two equivalent and therefore interchangeable calculation steps in which the correction is linearly dependent on the displacement velocity. By contrast with the simpler correction variant of formulas (2) and (3), this correction includes an additional coefficient A, which takes the following consideration into account. The inventors have found that the above-mentioned shear effect not only is proportional to the flow velocity, but also has a different effect on particles of different sizes, which in addition to the velocity-dependent error, results in a size-dependent error. The correction variants of formulas (4) and (5) also take this effect into account and lead to an even better measurement result as a second approximation, so to speak.

For this purpose, at least two calibration measurements of the decay rate Γⱼ(v) are carried out at different displacement velocities v for at least one first and one second particle size and the slope mⱼ and the axis intercept Γ_{0,j}=Γⱼ(v=0) are respectively determined from the linear relationship Γⱼ(v)=mⱼ·v+Γ_{0,j}, where the index j refers to the particle size. The coefficients A and B are then determined from the value pairs [Γ_{0,j},mⱼ] and the linear equation m(Γ₀)=A·Γ₀·+B.

In other words, different velocities are tuned for different particle sizes and in each case, the decay rate Γⱼ(v) is determined, wherein the different particles are used separately (i.e. monomodally). In this connection, it is beneficial to the accuracy of the subsequent measurement if in the calibration, particle sizes are used that lie within the range of the expected particle size that is to be measured.

As the value of the average particle size, the hydrodynamic radius r_{H} of the particles is derived in an intrinsically known way from the corrected or uncorrected decay rate Γ according to the following formula

$${r}_{H} = \frac{{q}^{2} \cdot {k}_{B} \cdot T}{6 \cdot π \cdot η \cdot Γ} \qquad ( 6 )$$

or is derived by inserting the following conversion term

$$Γ = \frac{{q}^{2} \cdot {k}_{B} \cdot T}{6 \cdot π \cdot η \cdot {r}_{H}} \qquad ( 7 )$$

into the correlation function g₂(τ), for example according to (1) or (1′), where in each case,

$$q = \frac{4 π {n}_{0}}{λ} \cdot sin ( \frac{θ}{2} )$$

is the scattering vector with the refractive index n₀ of the liquid medium, with the wavelength A of the laser light, and with the scattering angle θ, k_{B} is the Boltzmann constant, T is the ambient temperature, and η is the dynamic viscosity of the liquid medium. In this case, the decay rate Γ denotes the corrected decay rate Γ₀ as the upper term as well as the uncorrected decay rate Γ(v). The ambient temperature is usually measured, while the viscosity and the refractive index of the medium (e.g. n₀=1.33−solvents such as water or ethanol are used as the medium), the wavelength of the laser (e.g. λ=450 nm), and the average scattering angle (e.g. θ=90°) are known.

As already mentioned, the correction in step f) can also take place by means of a velocity-dependent correction of the derived hydrodynamic radius r_{H} itself.

According to one embodiment of the method, the hydrodynamic radius r_{H}(v) is derived from the uncorrected decay rate Γ(v) according to formula (6) and then corrected according to the following formula

$${r}_{H 0} = \frac{{r}_{H} ( v )}{1 - m \cdot v \cdot {r}_{H} ( v )} . \qquad ( 8 )$$

Alternatively, the following correction term

$${r}_{H} ( v ) = \frac{{r}_{H 0}}{m \cdot v \cdot {r}_{H 0} + 1} , \qquad ( 9 )$$

can be inserted into the conversion term (7). In this case, r_{H0} is the corrected hydrodynamic radius and m is a coefficient from a calibration of the radius determination with a variation of the displacement velocity v. The nomenclature for the hydrodynamic radius is based on that of the decay rate: r_{H} denotes the upper term for both the corrected hydrodynamic radius r_{H0} and the uncorrected hydrodynamic radius r_{H}(v).

In order to calibrate the radius determination for at least two different displacement velocities vᵢ, the hydrodynamic radius r_{H} (vᵢ) is determined according to steps a) to f) in conjunction with the conversion according to (6) or (7), but without correction. The value pairs [vᵢ,r_{H}(vᵢ)] obtained in this way have a function

$${r}_{H} ( v ) = \frac{1}{m \cdot v + b} \qquad ( 10 )$$

fitted to them from which the coefficient m is taken.

The device according to an embodiment of the invention comprises an optically transparent channel, a laser aligned with the channel in order to produce a laser beam, at least one detector aligned with the channel at a scattering angle to the laser beam, which is set up to generate two two-dimensional spatially resolved images of a scattered light pattern with a specific delay time τ in succession and to output them as digital image data, wherein the two images form an image pair and wherein the at least one detector is also set up to generate at least two image pairs with different delay times τ, and an electronic evaluation unit for the digital image data, which is set up to bring the scattered light patterns of the images of each image pair into coincidence with each other at least by means of relative displacement and thereby to respectively determine a maximum correlation value and a displacement amount s, to determine a displacement velocity v from at least one of the displacement amounts s of the at least two image pairs and from the associated delay time τ, to determine at least one coefficient of a correlation function g₂(τ) that is dependent on the delay time τ from the correlation values of the at least two image pairs by means of a numerical fitting, to derive a value for the average particle size from the at least one coefficient, and thereby to carry out a correction as a function of the determined displacement velocity v.

The at least one detector can, for example, be formed by a CMOS sensor or a CCD sensor including the respective electronic readout unit. The sensor and electronic readout unit are also referred to as a camera in the following. When designing the detector, it is necessary to take into account the fact that the delay time τ preferably varies in a range from one or more microseconds to one or more milliseconds. The at least one detector must therefore be able to generate images with the required resolution and at the required frequency. This can be implemented using a detector with a sensor that can be read out very quickly or alternatively using two detectors that are each oriented at the same channel section, wherein the detectors can then be read out simultaneously or overlapping in time and therefore more slowly. The second image pair and further image pairs can be generated by the same detector or detectors at time intervals that are long enough for the subsequent readout and any data storage and/or processing. The electronic evaluation unit preferably has a data memory that is equipped to store the image data output by the detector or detectors. It also has a processor that is configured, for example by means of a program code, to process the image data, in particular to filter, compress, crop, and above all to evaluate it as described above. Preferably the same processor or optionally a different processor is used to control the laser and the detector or detectors and thus trigger the capture of images.

The arrangement of the channel, the laser, and the detector in relation to one another is preferably such that, first, an angle of approximately 900 is enclosed between the laser beam and the viewing axis or axes of the detector (hereinafter camera axis), an angle of approximately 90° is enclosed between the laser beam and the flow direction in the channel, and an angle of approximately 90° is enclosed between the camera axis or axes and the flow direction in the channel. In this case, the three axes ideally form a right-angled coordinate system. Alternatively, it has proven to be advantageous if an angle of approximately 90° is enclosed between the laser beam and the camera axis or axes, an angle of approximately 0° is enclosed between the laser beam and the flow direction in the channel, and an angle of approximately 90° is enclosed between the camera axis or axes and the flow direction in the channel. The important thing is for an angle of approximately 90° to be maintained between the flow direction in the channel and the camera axes so that the flow compensation can take place reliably.

### BRIEF DESCRIPTION OF THE DRAWINGS

Other advantages and details of the invention are explained below with reference to the figures in the drawings. In the drawings:

FIG. 1 shows an image of a scattered light pattern of nanoparticles using a CMOS detector camera;

FIG. 2 shows a graph with the measurement data of the maximum correlation values, with and without displacement (flow compensation) and the displacement amounts, each plotted over the delay time;

FIG. 3 shows a graph of the derived diameters as a function of the flow rate for three different particle diameters,

FIG. 4 shows a graph of the determined displacement velocity as a function of the applied flow rate;

FIG. 5 shows a graph of the determined decay rate as a function of the determined displacement velocity for the three different particle diameters;

FIG. 6 shows a graph of the slopes of the linear relationships between the decay rate and displacement velocity from the graph in FIG. 5 as a function of the decay rate without flow for the three different particle diameters;

FIG. 7 shows a graph of the particle diameters determined as a function of the flow rate after correction;

FIG. 8 shows a graph of the determined particle diameters as a function of the determined displacement velocity for determining a radius correction; and

FIG. 9 shows a graph of the corrected particle diameters as a function of the flow rate.

### DETAILED DESCRIPTION

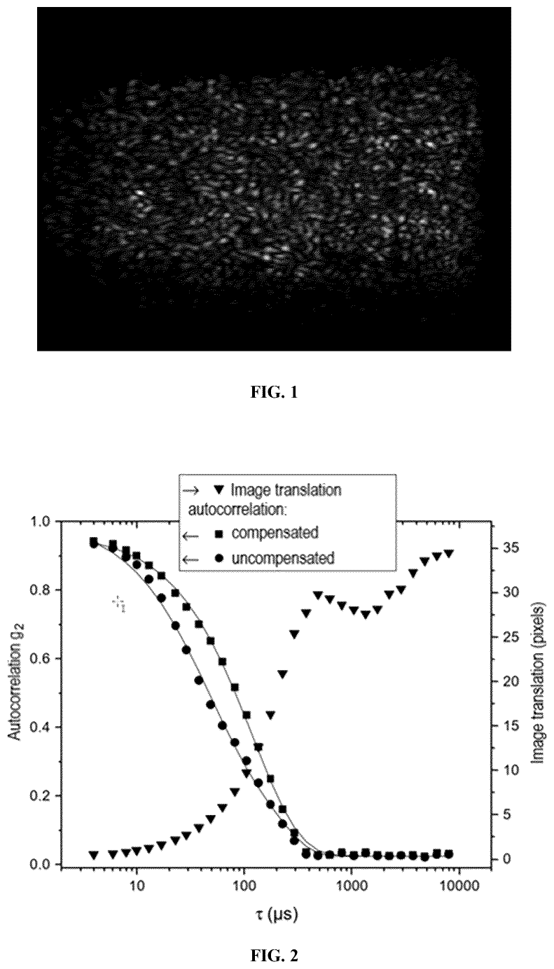

FIG. 1 shows a typical image of a scattered light pattern generated with the device according to the invention. A CMOS camera was used for this. A similar image is generated with a time delay of r by a second camera of the same type. By splitting the images of such an image pair between two CMOS cameras, measurements with correlation or delay times τ are possible that are much smaller than the maximum frame rate of the individual cameras.

The use of two cameras or detectors that generate images of the same sample volume, for example by means of a beam splitter, however, requires an additional, initial, static calibration step since the orientations of the cameras in relation to the sample routinely differ slightly. This necessitates a transformation I′₂=T_{s,t,Φ}(I₂) of one of the two images I₁ and I₂, whereby the components s and t of the transformation represent a displacement of the image in pixels in the x direction and the y direction, respectively, and the component φ of the transformation represents a rotation of the image. These components are determined by taking an image of the scattered light with both cameras at the same time t and numerically determining those components s, t, and φ for which the normalized cross-correlation γ of the two images is maximized:

$$γ ( {I}_{1} , {T}_{s , t , Φ} ( {I}_{2} ) ) = γ ( {I}_{1} , {I}_{2}^{′} ) = \frac{{\sum }_{x , y} [ {I}_{1} ( x , y ) - \overline{{I}_{1 x , y}} ] [ {I}_{2}^{′} ( x , y ) - \overline{{I}_{2 x , y}^{′}} ]}{{\{ {\sum }_{x , y} {[ {I}_{1} ( x , y ) - \overline{{I}_{1 x , y}} ]}^{2} {\sum }_{x , y} {[ {I}_{2}^{′} ( x , y ) - \overline{{I}_{2 x , y}^{′}} ]}^{2} \}}^{0.5}}$$

Here, Σ_{x,y} is the summation over an image section that is selected to be small enough to ensure a complete overlap of the two images even after displacement and rotation of the image I₂.

This is advantageously followed by a second calibration step. This serves to determine the flow direction, regardless of whether one or two detectors were used. This requires two images I₁(t=0) and I₂(t=τ) of the scattered light that are separated by a delay time τ>0. The delay time is 100 μs, for example. The ensemble of light-scattering particles moves collectively by a certain distance in one direction during the delay time τ. This results in the same displacement of the scattered light pattern, which must be compensated for (flow compensation) by bringing the scattered light patterns of the images I₁(t=0) and I₂(t=τ) into coincidence with each other by means of a relative displacement. The displacement is carried out in pixels as the unit of measure by means of the components s_{flow} in the x direction and t_{low} in the y direction, which components are in turn determined by maximizing the cross-correlation γ(I₁(t=0), I′₂(t=τ)) between the two images. As a result of the calibration, the flow direction \vec{e_{flow}} can be determined from this as a vector that is the length of one unit.

During the measurement to determine the particle size, the laser and/or the cameras are triggered with different delays τᵢ to generate the image pairs. The images from the cameras are transmitted to the electronic evaluation unit. The static transformation T_{u,v,Φ} from the first calibration is applied to the second image I₂(τᵢ) of each image pair when using two detectors, for example. For flow compensation, the displacement amount s(τᵢ) is determined for each image pair I₁(t=0) and I′₂(t=τᵢ) by finding the value of s(τᵢ) at which the cross-correlation between Iᵢ(t=0) and I″₂(t=τᵢ) is maximized. Here, I″₂(t=τᵢ) is the image I′₂(t=τᵢ) displaced by s(τᵢ)·\vec{e_{flow}} in the flow direction. A Nelder-Mead algorithm is preferably used for this optimization problem, in which the computational effort is reduced to a one-dimensional problem by using the flow direction \vec{e_{flow}} determined in the second calibration step described above. The maximum correlation value g₂(τᵢ) is then given as the cross-correlation between the image I₁(t=0) and I″₂(t=τᵢ).

Basically, the images of an image pair at i>0 can be triggered either by triggering only the laser or only the camera or by triggering both components synchronously. The following triggering scheme is preferred:
Exposure of camera 1 starts,
Laser pulse 1 on,
Laser pulse 1 off,
Exposure of camera 1 ends,
Exposure of camera 2 starts,
Laser pulse 2 on with spacing of τ>0 relative to laser pulse 1,
Laser pulse 2 off,
Exposure of camera 2 ends.

Alternatively, the laser can also remain switched on continuously between the two exposures if the exposure time of the cameras can be selected to be short enough. With many cameras, however, this cannot be set to less than 100 μs, for example, which is why correlation times <100 μs can only be measured with a pulsed laser.

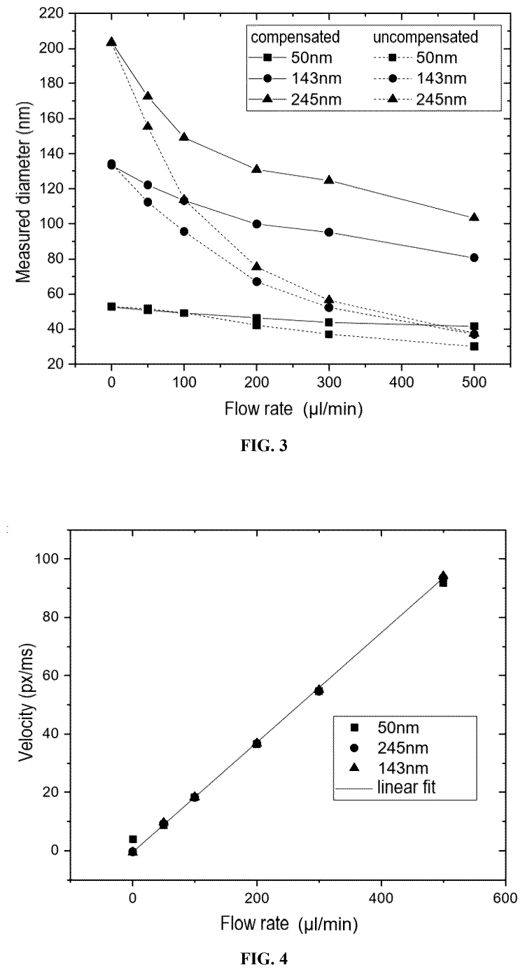

FIG. 2 shows the result graph of a measurement of the maximum correlation values g₂(τᵢ) without flow compensation (not part of the invention) as circles and compared to the maximum correlation values g₂(τᵢ) using flow compensation as squares and the associated displacement amounts s(τᵢ) in pixels as triangles, each plotted over the associated delay times τᵢ in ρs. The correlation values are normalized and range between 0 and 1, with a value of 0 indicating no correlation and a value of 1 indicating complete agreement between the two images. Furthermore, a fitted curve in the form of the following exponential function (correlation function) is shown in the graph in FIG. 2 for each of the two correlation measurement series

$${g}_{2} ( τ ) = {b}_{0} + β exp ( - 2 Γ ( v ) τ ) \cdot {( 1 + \frac{{μ}_{2}}{2 !} {τ}^{2} )}^{2} ,$$

where b₀ is the baseline of the correlation function, β is a parameter for compensation of the measurement sensitivity, and μ₂ is a parameter for describing the decay rate distribution. In this case, the series from the exponential function (1) was therefore terminated after the first summand.

As is apparent in FIG. 2, the correlation values g₂(τᵢ) without compensation of the displacement begin to fall earlier than the compensated values because the contribution of the flow motion to the decorrelation is initially greater than that of the Brownian motion. This results in a flatter exponential decay of the correlation function g₂(τ) or put another way, mathematically results in a higher decay rate Γ, as a result of which the particle size derived from this is much smaller than the actual particle size. For example, the radius determined with flow compensation is 80.6 nm compared to an uncompensated value of 37.1 nm. In addition, the shape of the uncompensated correlation function deviates from that of a simple exponential decay, which leads to an excessively high μ₂ and thus to a greatly overestimated width of the particle size distribution. Furthermore, the velocity v of the particles is determined from the displacement values s(τᵢ) in FIG. 2 as follows

$$v = \frac{{\sum }_{i} s ( {τ}_{i} )}{{\sum }_{i} {τ}_{i}} ,$$

with the summation only being carried out over those values at which g₂(τᵢ)>0.3 because at higher τᵢ the scattered light patterns are already so significantly decorrelated due to the Brownian motion of the particles that artifacts are increasingly registered there.

However, as the inventors have discovered, the flow compensation in microfluidic channels alone is not sufficient. To demonstrate this, the described compensation was tested in a rectangular microchannel with dimensions of 500 μm×500 μm and at different flow rates of up to 500 μl/min, which corresponds to an average velocity of 33 mm/s, with model particles of different particle diameters, each with very narrow size distributions.

FIG. 3 shows a graph, which depicts a comparison of flow-compensated measurements (solid lines) and uncompensated measurements (dashed lines, not part of the invention) of the particle diameters in nm plotted over the flow rate in μl/min. It is apparent that with larger particle diameters of 143 nm (circles) and 245 nm (triangles) and at flow rates of 200 μl/min and above, the uncompensated diameters are very close to one another and it becomes difficult to distinguish between the particles. At a flow rate of 500 μl/min, the uncompensated system measures diameters of 37.1 and 37.6 nm.

Although this problem no longer exists when using flow compensation, there is a further influence of the flow, particularly in small channels, which ensures that the derived particle diameter appears to decrease as the flow rate increases. The measurement result is thus clearly dependent on the flow rate. This is attributed to the shear forces along the channel walls, which result in a non-homogeneous velocity distribution across the channel cross-section. The non-homogeneous velocity distribution influences the measurement result in two ways: On the one hand, the flow compensation described above includes a homogeneous displacement of the scattered light patterns of both images, whereby the slower particles near the channel walls are displaced too far and those in the center of the channel are displaced too little. On the other hand, the non-homogeneous velocity distribution also directly influences the decorrelation of the scattered light patterns, which clearly leads to an underestimation of the resulting particle sizes, see M. Hoppenbrouwers, W. van de Water, Dynamic light scattering in shear flows, Physics of Fluids 10 (9), pp. 2128-2136, 1998. DOI: 10.1063/1.869734; and D. Genoe, P. van Puyvelde, E. Peuvrel-Disdier, P. Navard, G. Fuller, Dynamic light scattering in shear: measurements of diffusion coefficients, Polymer 40 (6), pp. 1353-1357, 1999. DOI: 10.1016/S0032-3861(98)00366-8.1,2.

Since this is clearly an effect that depends on the flow rate, first an investigation of the relationship between the selected flow rate and the determined displacement velocity v was carried out. This is shown in FIG. 4, where the determined displacement velocity in pixels/ms is plotted on the y-axis over the flow rate in μl/min on the x-axis. As is apparent, there is a very good linear relationship between them. The conclusion drawn from this is that the displacement velocity v, which is included in the measurement so to speak, can be used to compensate for the shear effect.

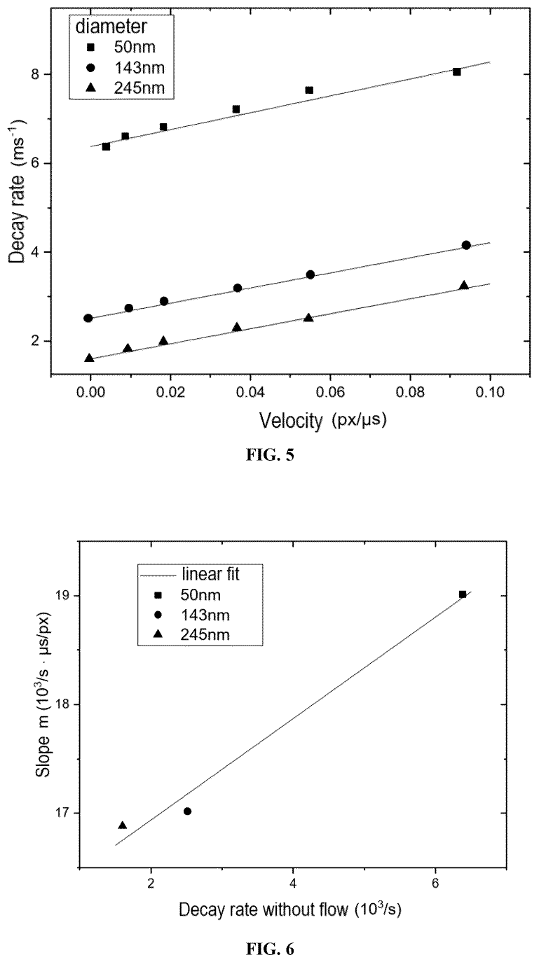

The graph in FIG. 5 shows the same result of the flow-compensated measurements as that in FIG. 3 with a different parameterization. This time, instead of the derived particle diameters, the determined, inversely proportional decay rate Γ(v) in ms⁻¹ is plotted over the displacement velocity v in pixels/μs for all three particle sizes. The first approximation shows a linear relationship, which can be determined in the following linear equation for each of the particle radii j:

$${Γ}_{j} ( v ) = {m}_{j} \cdot v + {Γ}_{0 , j} . \qquad ( {3}^{′} )$$

This linear relationship can be used directly for a quick shear compensation by using a single particle radius for calibration. If, for example, a linear fit is used to determine the slope m from the decay rate Γ(v) of such a calibration measurement, then by inserting the function

$$Γ ( v ) = m \cdot v + {Γ}_{0} \qquad ( 3 )$$

into the correlation function g₂(τ) (equation (1) or (1′)), the shear-compensated decay rate Γ₀ can be determined. This quick compensation is already quite accurate, but does not yet take into account the influence of the particle size on the shear effect. With the choice of an arbitrary particle radius for this shear compensation, a maximum relative error of less than 9% was determined. On the other hand, the quick shear compensation in this first approximation only requires calibration with one particle size, which simplifies the calibration.

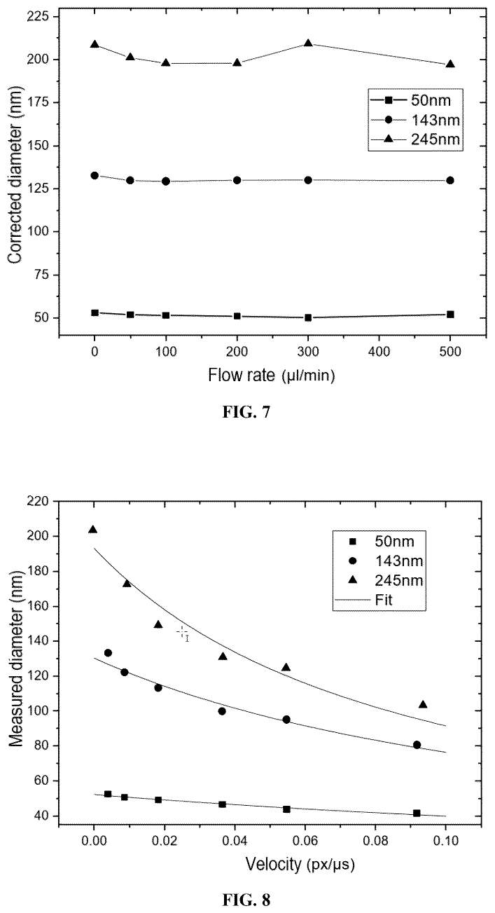

FIG. 6 shows a graph in which the previously determined slopes mⱼ of different particle diameters are depicted in ms⁻¹ μs/pixel as a function of the decay rate of a static sample Γ_{0,j}=Γⱼ(v=0), i.e. a measurement without flow, expressed in ms⁻¹. It is not necessary to carry out a measurement without flow for this because the decay rate Γ₀, of the static sample can likewise be inferred as a coefficient (y-intercept) from the linear equation (3′). In the graph, it is clear that the slopes mⱼ once again exhibit a linear dependence on the particle size in the first approximation. Therefore in the next step, the slopes mⱼ are once again fitted with a linear function:

$$m ( {Γ}_{0} ) = A \cdot {Γ}_{0} + B$$

This linear equation inserted into the linear relationship between the decay constant and the displacement velocity Γ(v)=m·v·+Γ₀ yields

$$Γ ( v ) = ( A \cdot {Γ}_{0} + B ) \cdot v + {Γ}_{0} = {Γ}_{0} \cdot ( A \cdot v + 1 ) + B \cdot v . \qquad ( 5 )$$

By inserting this function into the correlation function g₂(τ) (equation (1) or (1′)), an improved shear compensation of the decay rate Γ₀ can be achieved, which also takes into account the influence of the particle size on the shear effect. Here, the difference relative to the quick shear calibration according to (3) clearly lies in the fact that the parameter A becomes zero and B becomes the slope m. The parameter A therefore represents the influence of the particle size, which was missing before, making the correction somewhat more accurate overall. The maximum relative error across all particle sizes here only amounts to less than 5%.

As an alternative to the above-described method of inserting the correction term from (3) or (5) into the correlation function g₂(τ), the uncorrected decay rate Γ(v) can also be first determined in an equivalent manner and then the terms can be solved for Γ₀, where in the first case a subsequent correction according to the formula

$${Γ}_{0} = Γ ( v ) - m \cdot v \qquad ( 2 )$$

is carried out and in the second case a subsequent correction according to the formula

$${Γ}_{0} = \frac{Γ ( v ) - B \cdot v}{1 + A \cdot v} \qquad ( 4 )$$

is carried out. The derived parameters A and B are also used to correct any decay rate measured at velocities that are not equal to zero.

As already explained above, the decay rate Γ₀ that is corrected in either of these ways can be used to derive the corrected hydrodynamic radius r_{H,0} of the particles as a value of the average particle size according to the following formula

$${r}_{H , 0} = \frac{{q}^{2} \cdot {k}_{B} \cdot T}{6 \cdot π \cdot η \cdot {Γ}_{0}} . \qquad ( {6}^{′} )$$

FIG. 7 shows the result as the particle diameter in nm as a function of the flow rate in μl/min. It is clear that the measurement result is virtually constant for particle diameters up to approx. 150 nm and flow rates up to 500 μl/min and is also significantly less influenced by the flow rate for particle diameters of approx. 250 nm compared to the result without shear compensation in FIG. 3. As already mentioned, the maximum relative error is less than 5% for all particle sizes.

At this point, it should be mentioned again that in an equivalent manner, the uncorrected hydrodynamic radius r_{H}(v) can also be determined first and only then corrected by means of the following correction term

$${r}_{H 0} = \frac{{r}_{H} ( v )}{1 - m \cdot v \cdot {r}_{H} ( v )} \qquad ( 8 )$$

or alternatively the correction term

$${r}_{H} ( v ) = \frac{{r}_{H 0}}{m \cdot v \cdot {r}_{H 0} + 1} \qquad ( 9 )$$

that is solved for r_{H} (v) can be inserted into equation (7) and this can then be inserted into the correlation function g₂(τ).

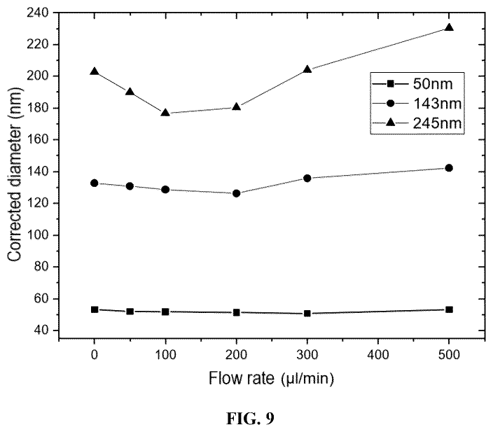

A further alternative shear compensation method is explained using the graphs in FIGS. 8 and 9. In FIG. 8, the determined, uncorrected particle radii r_{Hj}(v) in nm are once again plotted as a function of the determined displacement velocity v in pixels/μs for three different particle diameters, as in FIG. 3. This time, the measured values vⱼ and r_{H}(vⱼ) were fitted with the function

$${r}_{H j} ( v ) = \frac{1}{{m}_{j} \cdot v + {b}_{j}} \qquad ( 10 )$$

from which the coefficient mⱼ is taken. Inserting the average value m=m̅ⱼ for all three particle radii into the inverse function

$${r}_{H 0} = \frac{1}{1 / {r}_{H} ( v ) - m \cdot v} ,$$

likewise yields the diameter in nm, which in the graph in FIG. 9, is plotted over the flow rate in μl/min. As expected, a comparison with the result from FIG. 7 shows that this compensation once again produces a greater inaccuracy, especially for larger particle diameters, because here, too, the particle size has not been taken into account in the correction, but for diameters up to approx. 150 nm, reliable values are determined within an acceptable error range of less than 5%.

Using three exemplary fitting functions (3), (5), or (10), it has been possible to demonstrate that the teaching of the invention is basically not limited to a specific fitting function for compensating the velocity-dependent correction of the decay rate or particle size. With regard to a simple calibration here, it is advantageous to start from a function that preferably has no more than two fitting parameters.

1. A method for determining the average particle size of particles in a flowing liquid medium by means of dynamic light scattering (DLS), in which
a) the medium is conveyed through an optically transparent channel (step a)),
b) during which time the medium is irradiated with laser light (step b)),
c) scattered laser light is detected in a two-dimensional spatially resolved manner by means of one or more optical detectors such that an image is generated, wherein each image has a scattered light pattern, wherein two images forming an image pair are generated in succession with a specific delay time τ, and wherein at least two image pairs with different delay times τ are generated (step c)),
d) the scattered light patterns of the images of each image pair are brought into coincidence with each other by means of relative displacement, wherein a maximum correlation value and a displacement amount s are respectively determined (step d)),
e) a displacement velocity v is determined from at least one of the displacement amounts s of the at least two image pairs and from the associated delay time τ (step e)),
f) at least one coefficient of a correlation function g₂(τ) that is dependent on the delay time τ is determined from the correlation values of the at least two image pairs by means of a numerical fitting and a value for the average particle size is derived from the at least one coefficient, wherein a correction is made as a function of the determined displacement velocity v (step f)).

2. The method according to claim 1,
characterized in that the correlation function g₂(τ) is an exponential function and the at least one determined coefficient is a decay rate Γ(v).

3. The method according to claim 2,
characterized in that the correlation function is
$${g}_{2} ( τ ) = {b}_{0} + β exp ( - 2 Γ ( v ) τ ) \cdot {( 1 + \frac{{μ}_{2}}{2 !} {τ}^{2} + … )}^{2} \qquad ( 1 )$$
where b₀ is the baseline of the correlation function, β is a parameter for compensation of the measurement sensitivity, and the coefficients μₙ of the series
$${\sum }_{n = 2}^{∞} {( - 1 )}^{n} \frac{{μ}_{n}}{n !} {τ}^{n}$$
are parameters for describing the decay rate distribution, and where the series
$${{\sum }_{n = 2}^{∞} {( - 1 )}^{n} \frac{{μ}_{n}}{n !} {τ}^{n} )}^{2}$$
is optionally set equal to zero or terminated after the first summand
$$\frac{{μ}_{2}}{2 !} {τ}^{2}$$
or later
or optionally is
$${g}_{2} ( τ ) = {b}_{0} + β exp ( - 2 Γ ( v ) τ + 2 \cdot {\sum }_{n = 2}^{∞} {( - 1 )}^{n} \frac{{κ}_{n}}{n !} {τ}^{n} ) \qquad ( 1 ’ )$$
where b₀ is the baseline of the correlation function, β is a parameter for compensation of the measurement sensitivity, and the coefficients κₙ of the series
$${\sum }_{n = 2}^{∞} {( - 1 )}^{n} \frac{{κ}_{n}}{n !} {τ}^{n}$$
are parameters for describing the decay rate distribution and where the series
$${\sum }_{n = 2}^{∞} {( - 1 )}^{n} \frac{{κ}_{n}}{n !} {τ}^{n}$$
is optionally set equal to zero or terminated after the first summand
$$\frac{{κ}_{2}}{2 !} {τ}^{2}$$
or later.

4. The method according to claim 1,
characterized in that the correction in step f) is linearly dependent on the determined displacement velocity v.

5. The method according to claim 2,
characterized in that the correction in step f) is carried out optionally by inserting a velocity-dependent correction term into the correlation function g₂(τ) or by means of a velocity-dependent correction of the at least one determined coefficient or by means of a velocity-dependent correction of a derived hydrodynamic radius r_{H}.

6. The method according to claim 5,
characterized in that the decay rate Γ(v) is corrected in step f) according to the following formula
$${Γ}_{0} = Γ ( v ) - m \cdot v \qquad ( 2 )$$
or the following correction term
$$Γ ( v ) = m \cdot v + {Γ}_{0} \qquad ( 3 )$$
is inserted into the correlation function g₂(τ),
where in each case Γ₀ is the corrected decay rate and m is a parameter from a calibration of the decay rate determination with variation of the displacement velocity v.

7. The method according to claim 6,
characterized in that in order to calibrate the decay rate determination for at least two different displacement velocities vᵢ, the decay rate Γ(vᵢ) is determined according to steps a) to f), but without correction, and a straight line is derived from the value pairs [vᵢ,Γ(vⱼ)], the slope of which constitutes the parameter m.

8. The method according to claim 5,
characterized in that the decay rate Γ(v) is corrected in step f) according to the following formula
$${Γ}_{0} = \frac{Γ ( v ) - B \cdot v}{1 + A \cdot v} \qquad ( 4 )$$
or the following correction term
$$Γ ( v ) = {Γ}_{0} \cdot ( A \cdot v + 1 ) + B \cdot v \qquad ( 5 )$$
is inserted into the correlation function g₂(τ),
where in each case Γ₀ is the corrected decay rate and A and B are coefficients from a calibration of the decay rate determination with variation of the displacement velocity v.

9. The method according to claim 8,
characterized in that, in order to calibrate the decay rate determination for at least a first and second particle size, at least two respective measurements of the decay rate Γⱼ(v) are carried out at different displacement velocities v and in each case the slope mⱼ and the axis intercept Γ_{0,j}=Γⱼ(v=0) are determined from the linear relationship Γⱼ(v)=mⱼ·v+Γ_{0,j}, where the index j refers to the particle size,
and in that the coefficients A and B are determined from the value pairs [Γ_{0,j},mⱼ] and the linear equation m(Γ₀)=A·Γ₀+B.

10. The method according to claim 9,
characterized in that as the value of the average particle size, the hydrodynamic radius r_{H} of the particles is derived from the corrected or uncorrected decay rate Γ according to the following formula
$${r}_{H} = \frac{{q}^{2} \cdot {k}_{B} . T}{6 \cdot π \cdot η \cdot Γ} \qquad ( 6 )$$
or is derived by inserting the following conversion term
$$Γ = \frac{{q}^{2} \cdot {k}_{B} . T}{6 \cdot π \cdot η \cdot Γ} \qquad ( 7 )$$
into the correlation function g₂(τ),
where in each case,
$$q = \frac{4 π {n}_{0}}{λ} \cdot sin ( \frac{θ}{2} )$$
is the scattering vector with the refractive index n₀ of the liquid medium, with the wavelength λ of the laser light, and with the scattering angle θ, k_{B} is the Boltzmann constant, T is the ambient temperature, and η is the dynamic viscosity of the liquid medium.

11. The method according to claim 10,
characterized in that the hydrodynamic radius r_{H}(v) is derived from the uncorrected decay rate Γ(v) according to formula (#) and corrected according to the following formula
$${r}_{H 0} = \frac{{r}_{H} ( v )}{1 - m \cdot v \cdot {r}_{H} ( v )} \qquad ( 8 )$$
or the following correction term
$${r}_{H} ( v ) = \frac{{r}_{H 0}}{m \cdot v \cdot {r}_{H 0} + 1} \qquad ( 9 )$$
is inserted into the conversion term (#),
where in each case, r_{H0} is the corrected hydrodynamic radius and m is a coefficient from a calibration of the radius determination with a variation of the displacement velocity v.

12. The method according to claim 11,
characterized in that in order to calibrate the radius determination for at least two different displacement velocities vᵢ, the hydrodynamic radius r_{H}(vᵢ) is determined according to steps a) to f), but without correction, and the value pairs [vᵢ,r_{H}(vᵢ)] have a function
$${r}_{H} ( v ) = \frac{1}{m \cdot v + b} \qquad ( 10 )$$
fitted to them from which the coefficient m is taken.

13. The method according to claim 1,
characterized in that the displacement velocity v is determined in step e) from the displacement amounts s and from the associated delay times i of at least two image pairs by averaging.

14. A device for determining the average particle size of particles in a flowing liquid medium by means of dynamic light scattering (DLS), the device comprising:
an optically transparent channel,
a laser aligned with the channel,
at least one detector aligned with the channel at a scattering angle to the laser beam, which is set up to generate two two-dimensional spatially resolved images of a scattered light pattern with a specific delay time τ in succession and to output them as digital image data, wherein the two images form an image pair and wherein the at least one detector is also set up to generate at least two image pairs with different delay times τ, and
an electronic evaluation unit for the digital image data, which is configured
to bring the scattered light patterns of the images of each image pair into coincidence with each other at least by means of relative displacement and thereby to respectively determine a maximum correlation value and a displacement amount s,
to determine a displacement velocity v from at least one of the displacement amounts s of the at least two image pairs and from the associated delay time τ, and
to determine at least one coefficient of a correlation function g₂(τ) that is dependent on the delay time τ from the correlation values of the at least two image pairs by means of a numerical fitting so as to derive a value for the average particle size from the at least one coefficient and thereby carry out a correction as a function of the determined displacement velocity v.
